(19) United States
(12) Patent Application Publication
(10) Pub. No.: US 2017/0067342 A1
(43) Pub. Date: Mar. 9, 2017

(54) SYSTEM AND METHOD FOR MONITORING UNDERGROUND WORKSITE

(71) Applicant: Caterpillar Underground Mining Pty. Ltd., South Burnie (AU)

(72) Inventor: Anthony K. N. Nelson, Burnie (AU)

(73) Assignee: Caterpillar Underground Mining Pty. Ltd., South Burnie (AU)

(21) Appl. No.: 14/844,389

(22) Filed: Sep. 3, 2015

(51) Int. Cl. E21F 17/18; E21C 35/24; G05B 15/02

(52) U.S. Cl. CPC E21F 17/18; G05B 15/02; E21C 35/24

(57) ABSTRACT

A system for monitoring an underground worksite having a plurality of machines is provided. The system includes a machine barrier detection module. The system also includes a personnel barrier detection module. The system further includes a barrier control module coupled to the machine bather detection module and the personnel barrier detection module. The system also includes an area isolation control module coupled to the barrier control module.

### TECHNICAL FIELD

The present disclosure relates to a system and method for monitoring an underground worksite, and more particularly to the system and method for monitoring the underground worksite having a plurality of automated machines operating thereon.

### BACKGROUND

In fleet management applications, a plurality of machines operating at an underground worksite is controlled by an operator from a remote operator station. In some cases, operation areas of the machines at the worksite require isolation from any obstructions, barriers, uncontrolled machinery, and/or personnel in order to eliminate risk of collision. The operation area is sometimes monitored by providing monitoring devices at entry gates of the worksite.

U.S. Pat. No. 4,722,574 describes a personnel detection and protection system comprises sensor means for detecting the presence of personnel in a prohibited operational zone, and for deriving signal means indicative of such a detected presence, and control means responsive to the deriving of such signal means to control the operation or movement of equipment in the prohibited zone.

### SUMMARY OF THE DISCLOSURE

In one aspect of the present disclosure, a system for monitoring an underground worksite having a plurality of machines is provided. The system includes a machine barrier detection module configured to generate a signal indicative of a presence of a machine barrier associated with the plurality of machines. The system also includes a personnel barrier detection module configured to generate a signal indicative of a presence of a personnel barrier associated with the underground worksite. The system further includes a barrier control module coupled to the machine barrier detection module and the personnel barrier detection module. The barrier control module is configured to receive the signal indicative of the presence of the machine barrier. The barrier control module is also configured to receive the signal indicative of the presence of the personnel barrier. The barrier control module is further configured to forward at least one of the received signals based, at least in part on an operational mode of the barrier control module. The system also includes an area isolation control module coupled to the barrier control module. The area isolation control module is configured to receive the forwarded signals from the barrier control module. The area isolation control module is also configured to receive a signal indicative of an operator command. The area isolation control module is further configured to determine the presence of at least one of the machine barrier and the personnel barrier based, at least in part, on the received signals. The area isolation control module is also configured to trigger a shutdown of the plurality of machines based on the determination.

In another aspect of the present disclosure, a method for monitoring an underground worksite having a plurality of machines is provided. The method includes receiving, by a barrier control module, a signal indicative of a presence of a machine barrier. The method also includes receiving, by the barrier control module, a signal indicative of a presence of a personnel barrier. The method further includes forwarding, by the barrier control module, at least one of the received signals based, at least in part on an operational mode of the barrier control module. The method includes receiving, by an area isolation control module, the forwarded signals from the barrier control module. The method also includes receiving, by the area isolation control module, a signal indicative of an operator command. The method further includes determining, by the area isolation control module, the presence of at least one of the machine barrier and the personnel barrier based, at least in part, on the received signals. The method includes triggering, by the area isolation control module, a shutdown of the plurality of machines based on the determination.

In yet another aspect of the present disclosure, a system for monitoring an underground worksite having a plurality of machines is provided. The system includes a machine barrier detection module configured to generate a signal indicative of a presence of a machine barrier associated with the plurality of machines. The system also includes a personnel barrier detection module configured to generate a signal indicative of a presence of a personnel barrier associated with the underground worksite. The system further includes a barrier control module coupled to the machine bather detection module and the personnel barrier detection module. The barrier control module is configured to receive the signal indicative of the presence of the machine barrier. The barrier control module is also configured to receive the signal indicative of the presence of the personnel barrier. The barrier control module is further configured to forward at least one of the received signals based, at least in part on an operational mode of the barrier control module. The system includes an area isolation control module coupled to the barrier control module. The area isolation control module is configured to receive the forwarded signals from the barrier control module. The area isolation control module is also configured to receive a signal indicative of an operator command. The area isolation control module is further configured to determine the presence of at least one of the machine barrier and the personnel barrier based, at least in part, on the received signals. The area isolation control module is configured to trigger a shutdown of the plurality of machines based on the determination. The system also includes a triggering module provided in association with each of the plurality of machines. The triggering module is coupled to the area isolation control module. The triggering module is configured to control at least one of the shutdown of an engine and a brake engagement of the associated machine based on the triggering.

Other features and aspects of this disclosure will be apparent from the following description and the accompanying drawings.

### BRIEF DESCRIPTION OF THE DRAWINGS

FIG. 1 is a schematic view of an exemplary underground worksite having a plurality of machines, according to one embodiment of the present disclosure;

FIG. 2 is a block diagram for a system of monitoring the underground worksite, according to one embodiment of the present disclosure; and

FIG. 3 is a flowchart for a method of monitoring the underground worksite having the plurality of machines, according to one embodiment of the present disclosure.

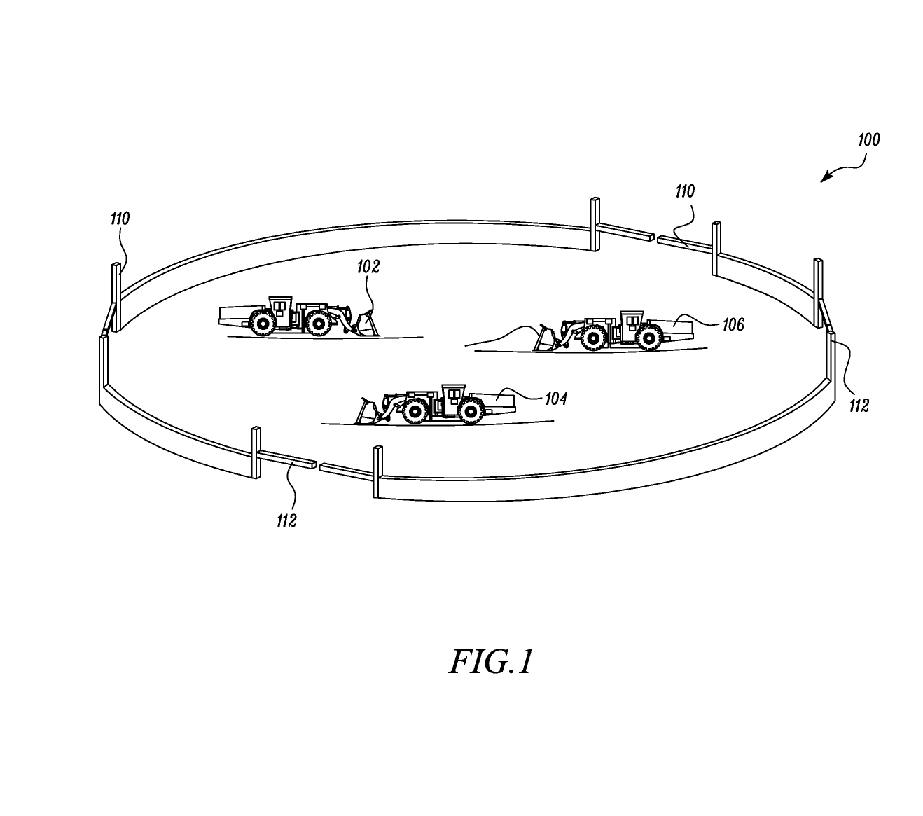

### DETAILED DESCRIPTION

Wherever possible, the same reference numbers will be used throughout the drawings to refer to the same or the like parts. FIG. 1 is a schematic view of an exemplary underground worksite 100, hereinafter referred to as worksite 100. The worksite 100 may embody an underground mine. A number of different machines 102, 104, 106 such as a load haul dump, may operate on the worksite 100 to perform various operations, such as, earth drilling, rock excavation, and the like. Although the machines 102, 104, 106 described in connection with this disclosure are embodied as load haul dump machines, alternatively the machines 102, 104, 106 may include any other type of same or different mining vehicles, such as those used for drilling, hammering, loading and unloading of payload, etc. without any limitation. Further, for the purpose of simplicity only three machines 102, 104, 106 are described as being deployed at the worksite 100. The number of machines operating at the worksite 100 may vary based on the application.

The machines 102, 104, 106 may be embodied as autonomous vehicles that are controlled by operators seated at a remote operator station 108. Typically, the remote operator station 108 may be located off the worksite 100. The remote operator station 108 may enable remote monitoring and/or controlling of various functions related to the operation of the machines 102, 104, 106 deployed on the worksite 100.

In one embodiment, the machines 102, 104, 106 may be communicably coupled to each other and to the remote operator station 108 via a communication system (not shown). The communication system may be, but not limited to, a local area radio network (LARN), a wide area network (WAN), a local area network (LAN), an Ethernet, an Internet, an Intranet, a cellular network, a satellite network, or any other suitable network for transmitting data between the machine 102, 104, 106 and the remote operator station 108. In various embodiments, the communication system may include a combination of two or more of the aforementioned networks and/or other types of networks known in the art. The communication system may be implemented as a wired network, a wireless network or a combination thereof. Further, data transmission between the machines 102, 104, 106 and the remote operator station 108 may occur over the communication system in an encrypted, any other secure format, or in any of a wide variety of known manners.

The worksite 100 may include at least one entry point and one exit point to allow ingress and egress of machines or persons, such as servicing or maintenance personnel. In the illustrated embodiment, the worksite 100 includes two entry points 110 and two exit points 112. Alternatively, the worksite 100 may include multiple entry and exit points. Further, in some embodiments, the entry and exit points 110, 112 may be located at the same physical location at the worksite 100. The entry and exit points 110, 112 may include suitable mechanisms to monitor the persons and the machines 102, 104, 106 entering or leaving the worksite 100 through the respective points 110, 112.

The machines 102, 104, 106 deployed on the worksite 100 may perform operations that require isolation of the worksite 100 or portions of the worksite 100. The present disclosure relates to a system 200 for monitoring the worksite 100 having the machines 102, 104, 106. More particularly, the system 200 is configured to allow shutdown of one or more machines 102, 104, 106 operating on the worksite 100 based on detection of a machine barrier or a personnel barrier proximate to the respective machine 102, 104, 106.

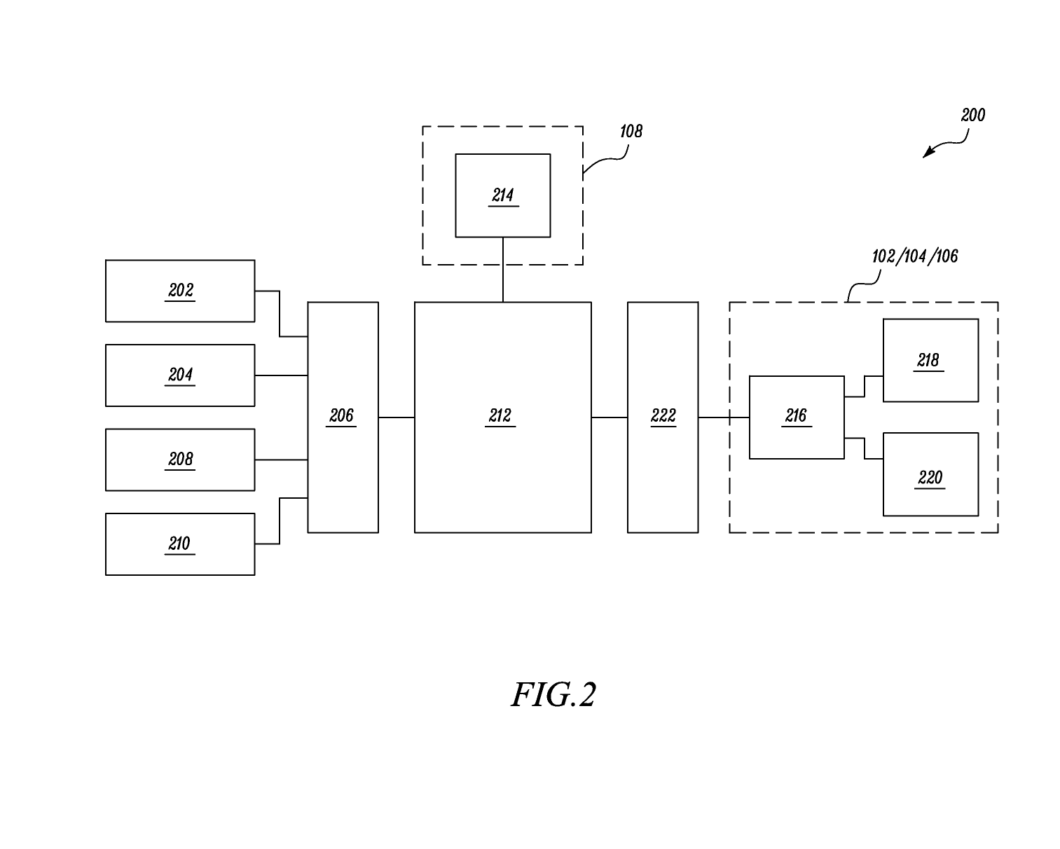

Referring to FIGS. 1 and 2, the system 200 includes a machine barrier detection module 202. The machine barrier detection module 202 is configured to generate a signal indicative of the machine barrier associated with the machines 102, 104, 106. For exemplary and illustrative purposes, the system 200 will be explained with respect to a single machine 102. The disclosure is equally applicable to other machines 104, 106 without any limitation.

In one example, the machine barrier detection module 202 may be configured to detect if a profile of the machine 102 matches a prefixed profile. The machine barrier detection module 202 may be mounted at locations at which the machine 102 is prohibited from entering. The machine barrier detection module 202 may include lanyard switches. The lanyard switch may include a wire. When the machine 102 enters a restricted zone or area on the worksite 100, the machine 102 contacts with the wire of the lanyard switch, thereby generating a signal indicative of a presence of the machine barrier on the worksite 100. In another example, the machine barrier detection module 202 may include a light curtain. Alternatively, the machine barrier detection module 202 may include other machine barrier detection means without any limitations.

The system 200 also includes a personnel barrier detection module 204. The personnel barrier detection module 204 is configured to generate a signal indicative of a presence of a personnel barrier associated with the worksite 100. The personnel barrier detection module 204 may include a gate proximity switch. The gate proximity switch is configured to generate a signal indicative of an opening or a closing of the entry point 110 of the worksite 100, thereby indicating a possible entry of the person at the worksite 100. In another example, the personnel barrier detection module 204 may include a LADAR or a light curtain. The LADAR and light curtain are configured to generate signals indicative of any movements in an area proximate to the mounting location of the respective LADAR or the light curtain. Alternatively, the personnel barrier detection module 204 may include any other personnel barrier detection means without limiting the scope of the present disclosure.

The system 200 includes a barrier control module 206. The barrier control module 206 is communicably coupled to the machine barrier detection module 202 and the personnel barrier detection module 204. The barrier control module 206 may be located proximate to the entry points 110 and exit points 112 of the worksite 100. The system 200 may include a number of barrier control modules 206 depending on the number of entry or exit points 110, 112. In one example, the system 200 includes one barrier control module 206. The communication between the barrier control module 206 and each of the machine barrier detection module 202 and the personnel barrier detection module 204 may be wired or wireless without any limitations.

As shown in the accompanying figures, the system 200 additionally includes a reset switch 208 associated with the barrier control module 206. The reset switch 208 is configured to generate a signal indicative of an operational mode of the barrier control module 206. More particularly, the reset switch 208 is configured to activate the barrier control module 206. The reset switch 208 may include any known push to start switch or on/off switch that is configured to activate the barrier control module 206.

The barrier control module 206 is configured to receive signals indicative of the presence of the machine barrier from the machine barrier detection module 202. Further, the barrier control module 206 is also configured to receive the signal indicative of the presence of the personnel barrier on the worksite 100. The signal indicative of the personnel barrier is received from the personnel barrier detection module 204.

The system 200 includes an emergency stop switch 210 associated and provided proximate to the barrier control module 206. In a situation wherein the person wishes to access the worksite 100, the person may activate the emergency stop switch 210. The emergency stop switch 210 is communicably coupled to the barrier control module 206. The barrier control module 206 is configured to receive a signal indicative of an emergency stop from the emergency stop switch 210, indicative of intent of the person to enter the worksite 100.

The barrier control module 206 is configured to forward the signals received from the machine barrier detection module 202, the personnel barrier detection module 204, the reset switch 208, and/or the emergency stop switch 210. The barrier control module 206 is configured to forward the signals received from the machine barrier detection module 202, the personnel barrier control module 204, the reset switch 208, and/or the emergency stop switch 210 to an area isolation control module 212.

Further, a remote stop switch 214 is provided at the remote operator station 108. The remote stop switch 214 is operated by an operator seated at the remote operator station 108. The remote stop switch 214 is indicative of an operator command wherein the operator indicates intended entry to the worksite 100 based on the activation of the remote stop switch 214. The remote stop switch 214 is communicably coupled to the area isolation control module 212.

As shown in the accompanying figures, the area isolation control module 212 is communicably coupled to the bather control module 206 and the remote operator station 108, and is configured to receive signals therefrom. In one embodiment, based on the detection of the presence of any one or both of the machine barrier, the personnel barrier, and the operational mode of the barrier control module 206, the barrier control module 206 may be configured to forward the signal to the area isolation module 212.

The area isolation control module 212 is configured to receive the signals forwarded by the barrier control module 206 and the remote stop switch 214 at the remote operator station 108. In another embodiment, based on the signals received, the area isolation control module 212 may configured to determine the presence of the machine barrier or the personnel barrier on the worksite 100. The area isolation control module 212 is also configured to determine if the person has requested the emergency stop to enter the worksite 100, based on the signals received from the remote stop switch 214. The area isolation control module 212 is configured to trigger a shutdown of one or more machines 102, 104, 106 operating on the worksite 100 based on the determination.

The system 200 includes a machine control module 222. The machine control module 222 is communicably coupled to the area isolation control module 212. The machine control module 222 may be provided proximate to the barrier control module 206. Additionally, the system 200 includes a triggering module 216. The triggering module 216 is associated with each of the machines 102, 104, 106 operating on the worksite 100. Accordingly, the machine control module 222 is coupled to each of the triggering modules 216 associated with the respective machines 102, 104, 106. The triggering module 216 may be present on-board the respective machine 102, 104, 106. In one example, the triggering module 216 may be a separate module that is configured to receive the signals from the machine control module 222. Alternatively, the triggering module 216 may be integrated with the electronic control module (ECM) of the respective machine 102, 104, 106 without any limitations.

The triggering module 216 may be coupled to an engine control module 218 and a braking module 220 of the respective machine 102, 104, 106. Based on the signals received from the area isolation control module 212, the triggering module 216 is configured to send signals to the engine control module 218 and the braking module 220 to shutdown an engine and/or engage a braking system of the respective machine 102, 104, 106 in order to halt the operation of the machine 102, 104, 106.

More particularly, in a situation wherein the barrier control module 206 is in the operational state and detects the presence of at least one of the machine barrier and the personnel barrier, the area isolation control module 212 determines from which barrier control module 206 the signals were received. Based on the determination, the area isolation control module 212 may trigger the shutdown of one or more machines 102, 104, 106 proximate to the location at which the presence of the machine barrier or the personnel barrier was detected. Further, when the person wishes to access the worksite 100 and actuates the emergency stop switch 210 associated with the barrier control module 206, the area isolation control module 212 sends the signal to the machine control module 222. Further, the machine control module 222 may then forward the signals to the respective triggering module 216.

The area isolation control module 212 and the triggering module 216 may embody a single microprocessor or multiple microprocessors for receiving signals from components of the system 200. Numerous commercially available microprocessors may be configured to perform the functions of the area isolation control module 212 and the triggering module 216. A person of ordinary skill in the art will appreciate that the area isolation control module 212 and the triggering module 216 may additionally include other components and may also perform other functions not described herein.

### INDUSTRIAL APPLICABILITY

The present disclosure relates to the system 200 for monitoring the worksite 100 having the machines 102, 104, 106. The machines 102, 104, 106 are operated by the operator at the remote operator station 108. The system 200 includes means to detect the presence of one or both of the machine barrier and the personnel barrier. Based on the detection, the system 200 is configured to temporarily shutdown the one or more machines 102, 104, 106 operating on the worksite 100. Further, the system 200 also includes means to temporarily halt the operation of the one or machines 102, 104, 106 operating on the worksite 100 for allowing authorized servicing or maintenance personnel to access the worksite 100. In one embodiment, the respective machine 102, 104, 106 operating proximate to the detection of the presence of the machine barrier and/or the personnel barrier are halted. The system 200 further allows the operator seated at the remote operator station 108 to shutdown the operation of the one or more machines 102, 104, 106 from the remote operator station 108.

The system 200 provides a reliable and accurate indication of the presence of the machine barrier or the personnel barrier, and accordingly shuts down the operation of selective machines 102, 104, 106 on the worksite that is proximate to the location of the machine or personnel barrier. Hence, the operation of other machines working at different areas on the worksite 100 is undisturbed or unaffected. Further, the system 200 is not worksite specific or machine specific, and hence may be employed at different worksites. The system 200 may be readily installed at a new worksite or may be retrofitted at an existing worksite.

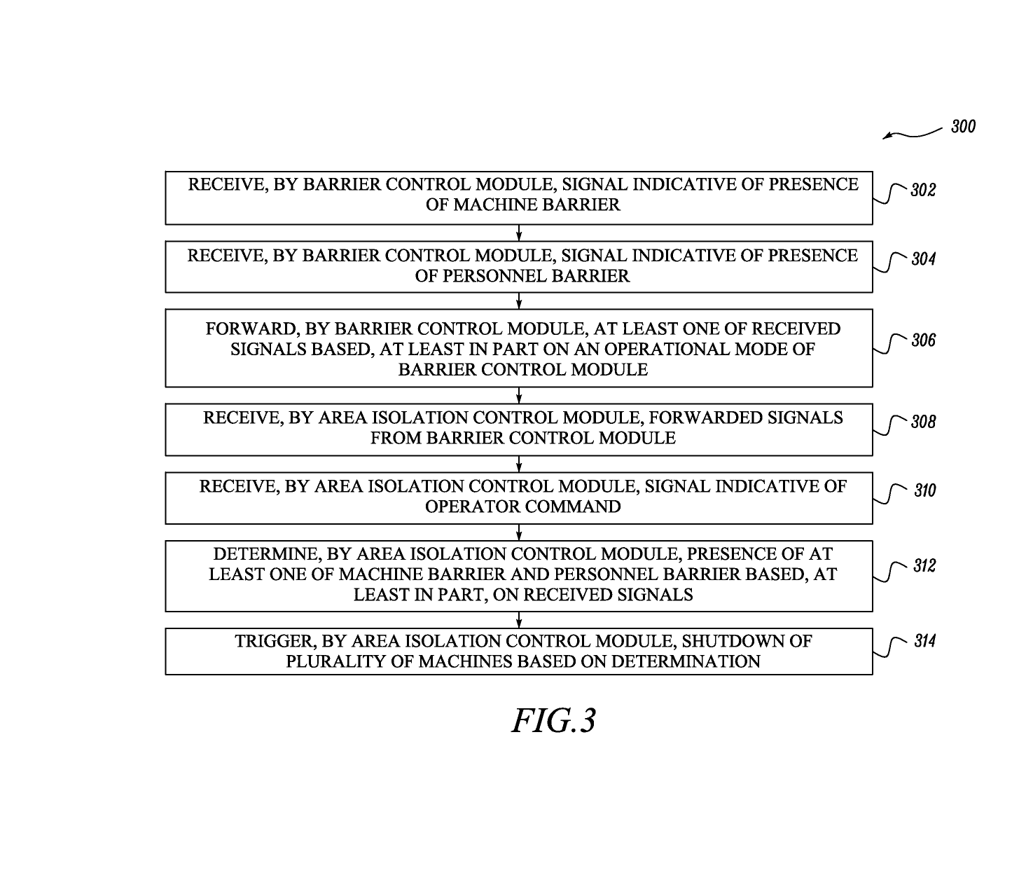

FIG. 3 is a flowchart for a method 300 of monitoring the worksite 100 having the machines 102, 104, 106. At step 302, the barrier control module 206 receives the signal indicative of the presence of the machine barrier. At step 304, the barrier control module 206 receives the signal indicative of the presence of the personnel barrier. At step 306, the barrier control module 206 forwards at least one of the received signals based, at least in part, on the operational mode of the barrier control module 206. The barrier control module 206 also receives the signal indicative of the emergency stop.

At step 308, the area isolation control module 212 receives the signals forwarded by the barrier control module 206. At step 310, the area isolation control module 212 receives the signals indicative of the operator command. At step 312, the area isolation control module 212 determines the presence of at least one of the machine barrier and the personnel barrier based, at least in part, on the received signals. At step 314, the area isolation control module 212 triggers the shutdown of one or more machines 102, 104, 106 operating on the worksite 100, based on the determination.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for monitoring an underground worksite having a plurality of machines, the system comprising:
a machine barrier detection module configured to generate a signal indicative of a presence of a machine barrier associated with the plurality of machines;
a personnel barrier detection module configured to generate a signal indicative of a presence of a personnel barrier associated with the underground worksite;
a barrier control module coupled to the machine barrier detection module and the personnel barrier detection module, the barrier control module configured to:
receive the signal indicative of the presence of the machine barrier;
receive the signal indicative of the presence of the personnel barrier; and
forward at least one of the received signals based, at least in part on an operational mode of the barrier control module; and
an area isolation control module coupled to the barrier control module, the area isolation control module configured to:
receive the forwarded signals from the barrier control module;
receive a signal indicative of an operator command;
determine the presence of at least one of the machine barrier and the personnel barrier based, at least in part, on the received signals; and
trigger a shutdown of the plurality of machines based on the determination.

2. The system of claim 1, wherein the machine barrier detection module includes at least one of a lanyard switch and a light curtain.

3. The system of claim 1, wherein the personnel barrier detection module includes at least one of a gate proximity switch, a LADAR, and a light curtain.

4. The system of claim 1 further comprising a triggering module associated with each of the plurality of the machines, wherein the area isolation control module is coupled to the triggering module.

5. The system of claim 4, wherein the triggering module is coupled to at least one of an engine control module and a braking module of each of the plurality of machines.

6. The system of claim 4, wherein the triggering module is positioned on-board each of the plurality of machines.

7. The system of claim 1 further comprising a reset switch associated with the barrier control module, the reset switch configured to generate a signal indicative of the operational mode of the barrier control module.

8. The system of claim 1, wherein the area isolation control module is coupled a remote operator station, the remote operator station configured to issue the signal indicative of the operator command.

9. The system of claim 1, wherein the barrier control module is further configured to receive a signal indicative of an emergency stop.

10. The system of claim 1, wherein the barrier control module is positioned proximate to an entry point of the underground worksite.

11. A method for monitoring an underground worksite having a plurality of machines, the method comprising:
receiving, by a barrier control module, a signal indicative of a presence of a machine barrier;
receiving, by the barrier control module, a signal indicative of a presence of a personnel barrier;
forwarding, by the barrier control module, at least one of the received signals based, at least in part on an operational mode of the barrier control module;
receiving, by an area isolation control module, the forwarded signals from the barrier control module;
receiving, by the area isolation control module, a signal indicative of an operator command;
determining, by the area isolation control module, the presence of at least one of the machine barrier and the personnel barrier based, at least in part, on the received signals; and
triggering, by the area isolation control module, a shutdown of the plurality of machines based on the determination.

12. The method of claim 11 further comprising:
receiving, by the barrier control module, a signal indicative of an emergency stop.

13. A system for monitoring an underground worksite having a plurality of machines, the system comprising:
a machine barrier detection module configured to generate a signal indicative of a presence of a machine barrier associated with the plurality of machines;
a personnel barrier detection module configured to generate a signal indicative of a presence of a personnel barrier associated with the underground worksite;
a barrier control module coupled to the machine barrier detection module and the personnel barrier detection module, the barrier control module configured to:
receive the signal indicative of the presence of the machine barrier;
receive the signal indicative of the presence of the personnel barrier; and
forward at least one of the received signals based, at least in part on an operational mode of the barrier control module;
an area isolation control module coupled to the barrier control module, the area isolation control module configured to:
receive the forwarded signals from the barrier control module;
receive a signal indicative of an operator command;
determine the presence of at least one of the machine barrier and the personnel barrier based, at least in part, on the received signals; and
trigger a shutdown of the plurality of machines based on the determination; and
a triggering module provided in association with each of the plurality of machines, the triggering module coupled to the area isolation control module, the triggering module configured to:
control at least one of the shutdown of an engine and a brake engagement of the associated machine based on the triggering.

14. The system of claim 13, wherein the machine barrier detection module includes at least one of a lanyard switch and a light curtain.

15. The system of claim 13, wherein the personnel barrier detection module includes at least one of a gate proximity switch, a LADAR, and a light curtain.

16. The system of claim 13, wherein the triggering module is positioned on-board each of the plurality of machines.

17. The system of claim 13, wherein the barrier control module is further configured to receive a signal indicative of an emergency stop.

18. The system of claim 13, wherein the barrier control module is positioned proximate to an entry point of the underground worksite.

19. The system of claim 13 further comprising a reset switch associated with the barrier control module, the reset switch configured to generate a signal indicative of the operational mode of the barrier control module.

20. The system of claim 13, wherein the area isolation control module is coupled a remote operator station, the remote operator station configured to issue the signal indicative of the operator command.
